(19) United States
(12) Patent Application Publication
(10) Pub. No.: US 2005/0076568 A1
(43) Pub. Date: Apr. 14, 2005

(54) Partial oxidation of cellulose spent pulping liquor

(76) Inventor: Lars Lennart Stigsson, Saltsjobaden (SE)

Correspondence Address: Lars L. Stigsson, Kvarnstugevagen 21, Saltsjobaden, 13336, SE

(21) Appl. No.: 10/681,233

(22) Filed: Oct. 9, 2003

(51) Int. Cl. B01J 3/00

(52) U.S. Cl. 48/197 FM; 48/62 R

(57) ABSTRACT

The present invention relate to a two-stage gasification process using a gas generator for the recovery of strongly alkaline chemicals and energy value from a cellulose spent liquor. The temperature in the first reaction zone of the gas generator is maintained between 1000 C. and 1400 C. by the controlled addition of an oxygen containing gas. A strongly alkaline smelt comprising alkali oxide, alkali hydroxide, alkali carbonate and alkali borate's corresponding to at least 75% by weight of the smelt is recovered from below the first reaction zone of the gas generator. A gaseous components stream formed by exothermal reactions in the first reaction zone are directed to a second reaction or gas transfer zone of substantially of updraft or up-flow design, wherein the gaseous stream is cooled to a temperature below about 1000 C, said cooling preferably achieved by endothermal decomposition of cellulose spent liquor injected into the gaseous stream.

This invention relates to the partial oxidation or gasification of cellulose spent liquor. More specifically, this invention relates to an apparatus and process for the conversion of spent cellulose pulping liquor to a gaseous component stream and a molten slag product of alkaline compounds having an alkali carbonate, alkali oxide, alkali hydroxide and alkali borate content corresponding to least 75% (by weight) of the molten slag. The molten slag product is separated from the gaseous component stream and thereafter dissolved in and aqueous liquid to form an alkaline raw cooking liquor with an alkali bicarbonate content lower than about 2 grams/liter.

### BACKGROUND TO THE INVENTION

In the production of pulp and paper using pulping processes such as the kraft process and the alkaline sulfur chemicals free soda process, digestion of wood with aqueous alkaline solutions results in the production of a by-product which is known as cellulose spent or black liquor, hereinafter also referred to as black liquor. In order to realize economies in the overall pulping process, this byproduct is recovered and converted into fresh pulping chemicals and energy. In particular, it is desired to regenerate alkali compounds, which can be used to reconstitute active alkaline solutions for the pulp digestion step of the process. In addition, it is desirable to utilize the black liquor as an energy source. While the base alkali metal in the pulping industry commonly is sodium, alkali in the following may be alkaline sodium or potassium compounds or combinations thereof.

In the kraft pulping process, lignin is separated from the wood matrix by digestion using a cooking liquor, the active components of which substantially consist of sodium hydroxide and sodium hydrogen sulfide. Precursors to these chemicals are formed in the lower section of the recovery furnace, wherein the black liquor is partially decomposed under reducing conditions. The alkali and sulfur compounds are reduced to form a melt substantially consisting of sodium carbonate and sodium sulfide. The inorganic chemicals form a pool of melt in the bottom of the recovery furnace, from where it is discharged to a dissolving tank. The melt is dissolved in an aqueous liquid in the dissolving tank, normally arranged adjacent to the recovery boiler. The solution thus obtained will mainly contain sodium carbonate, sodium sulfide and sodium hydroxide, and is usually called “green liquor”. This liquor is strongly alkaline and contains hydroxide ions formed by the hydrolysis of sodium sulfide.

A typical green liquor prepared from recovery boiler smelt dissolution used for the preparation of white liquor typically is composed of the following;

| | | |
|---|---|---|
| Sodium hydroxide, NaOH | 15-25 | grams/liter |
| Sodium sulfide, Na2S | 20-50 | grams/liter |
| Sodium carbonate, Na2CO3 | 90-105 | grams/liter |
| Sodium sulfate, Na2SO4 | 5-10 | grams/liter |

(all compounds calculated as NaOH)

To further increase alkalinity of the green liquor, downstream of the recovery boiler, the green liquor is treated with quick lime to convert the alkali carbonate to alkali hydroxide in accordance with well known causticizing practice shown by way of the following reaction,
Ca(OH)₂+Na₂CO₃=2NaOH+CaCO₃ (1)

The sodium sulfide does not participate in the causticizing reaction, however it contributes significantly to the alkalinity of the cooking liquor due to the hydrolysis of sodium sulfide to sodium hydroxide and hydrosulfide. The resulting liquor, which mainly consists of the active digesting chemicals sodium hydroxide and sodium hydrogen sulfide, is usually called “white liquor”. The calcium carbonate precipitate formed in the causticizing reaction is reburned in a lime kiln to recover the calcium oxide.

The digestion liquor (white liquor) used in the kraft process consists of sodium hydroxide and sodium sulfide as active pulping chemicals, as well as sodium carbonate. Furthermore, small amounts of Na₂SO₄, Na₂SO₃, and Na₂S₂O₃ from side reactions are present in the kraft pulping liquor. The following definitions are used to characterize white liquor, sodium equivalents expressed as Na₂O or NaOH being used to calculate the chemicals employed;

| | |
|---|---|
| Titratable alkali | NaOH + Na₂S + Na₂CO₃ |
| Active alkali | NaOH + Na₂S |
| Effective alkali | NaOH + ½ Na₂S |

The amount of chemicals required for pulping, their composition and the pulping parameters to be applied depend on the type of raw material used, the quality of pulp desired, and especially on the extent of delignification required. The production of semichemical or high-yield pulps requires between 10-15% of effective alkali, chemical pulp based on hardwoods requires 18-22%, and the corresponding softwood pulp 20-25% effective alkali, calculated in each case as NaOH. The liquor sulfidity, a commonly used term, is a measure of the sulfide content relative to the active alkali content. Sulfidity in kraft mill pulping liquors ranges from 20 to 40%.

The white liquor used as kraft cooking liquor, is typically composed of the following:

| | | |
|---|---|---|
| Sodium hydroxide, NaOH | 80-120 | grams/liter |
| Sodium sulfide, Na2S | 20-50 | grams/liter |
| Sodium carbonate, Na2CO3 | 10-30 | grams/liter |
| Sodium sulfate, Na2SO4 | 5-10 | grams/liter |

(all compounds calculated as NaOH)

The concentration of chemical compounds present in green and white liquor is typically between 150 and 200 g/l calculated as sodium hydroxide. Higher concentrations are undesirable due to precipitation of salts, and lower concentrations can undesirably dilute the cooking liquors and increase the load on the evaporators.

The causticizing operation of an alkaline pulp mill represent a major operating and capital cost item, and it is therefore important to preserve or increase the alkalinity of the green liquor throughout the recovery process. All contact between carbon dioxide and green and white liquor should be minimized to prevent undesired formation of bicarbonates and hydrogen sulfide release from the liquor.

Alkali borate's are known to exhibit autocausticising properties under conditions prevalent in the recovery boiler. Boron based autocausticising could potentially supply either part or all of the hydroxide requirements in the kraft pulping process. Janson initiated the use of borate's for autocausticising in the pulp and paper industry in 1976 and a US patent was granted to Janson in 1977, U.S. Pat. No. 4,116,759.

In their research, Janson and co-workers concluded that the presence of sulfide in the recovery boiler smelts counteracts the autocausticizing reactions of borate's, which would be an obvious drawback in kraft applications. Moreover, for sulfide containing smelts, the presence of carbon dioxide exacerbated the negative effect of sulfide. In the binary smelt system (Na₂S—B₂O₃), glass formation has been found to occur and compounds of the structure Na₂S-nB₂O₃ (n=2−4) are formed. Thus any sulfide present in the recovery boiler smelt would potentially bind to borate's, which else would be available for autocausticising reactions. Indeed more recent mill scale borate autocausticizing trials in kraft mills have indicated lower than expected autocausticising efficiency which may, at least partly, be due to the presence of sulfide.

In accordance with the stoichiometry suggested by Janson, the main autocaustisizing component formed in the recovery smelt is tetrasodium borate (Na₄B₂O₅). This compound will form one mole of hydroxide for every mole of boron when the smelt is dissolved to form green liquor in accordance with
Na₄B₂O₅+H₂O=2NaOH+NaBO₂ (2)

There are recent indications that a key borate compound formed in a recovery furnace smelt is trisodiumborate (Na₃BO₃), rather than the tetrasodium borate as suggested by Janson. The overall stoichiometry suggests that only half a mole of borate is needed to regenerate one mole of hydroxide in the liquor system in accordance with
Na₃BO₃+H₂O=2NaOH+NaBO₂ (3)

Based on the stoichiometry of reaction (3), two patents have been granted in USA relating to partial autocaustizing using borate's combined with traditional lime causticiszing, U.S. Pat. No. 6,294,048 and U.S. Pat. No. 6,348,128.

The phase equilibrium diagram of the binary smelt system Na₂O—B₂O₃ shows the existence of the compound trisodiumborate at molar ratios of sodium to boron over about 3:1 in the temperature range of 900 C. to 1000 C. Molar ratios over about 3:1 implies that a major portion of the smelt is unreacted carbonate which calls for additional causticizing by conventional means to provide sufficient alkalinity in the recovered cooking liquor. U.S. Pat. No. 6,294,048 and U.S. Pat. No. 6,348,128 are consequently focusing on partial autocaustisizing.

The conversion efficiency of reactants to form trisodiumborate in sodium carbonate—borate smelts is described for example in the text and figures of U.S. Pat. No. 2,146,093, “Method of producing caustic borate products”. A high reaction temperature, the higher the better, and at least 1050° C. is needed to obtain substantial quantities of trisodiumborate from the reactants. Nevertheless as high as 50 molar percent of the carbonate reactant is still left unreacted in the smelt (FIG. 3 and appended text to FIG. 3 in U.S. Pat. No. 2,146,093).

It is well known that alkali carbonate partly decomposes at temperatures above about 1150 C. to form sodium oxide (Na₂O), a compound which directly will form strong alkali upon dissolution in aqueous liquids. Sodium hydroxide, an active ingredient in alkaline pulping processes, are also formed in significant quantities at temperatures above about 1150 C. from decomposing cellulose spent liquor.

With this background it would be very desirable to design a chemicals recovery system permitting high smelt zone temperatures in the range of 1000 C.-1400 C., preferably over 1150 C., in order to establish conditions for the efficient recovery of trisodium borate (Na₃BO₃), sodium oxide (Na₂O) and sodium hydroxide (NaOH). In such a recovery system it is of key importance to preserve alkalinity of the smelt and to avoid contact between product alkaline liquors and carbon dioxide, or else the advantage of providing high direct alkalinity by autocausticizing is lost.

The most widely practiced method of processing black liquor is the Tomlinson recovery furnace (also referred to as the Tomlinson recovery boiler). Recovery boilers are operated and designed for operation in the temperature range of 900-1000 C. Higher temperatures in the smelt zone is not permitted due to exponentially increased alkali fumes generation and carryover. From the discussion above it is apparent that the recovery boiler therefore is not ideal for the recovery of sodium triborate and other highly alkaline autocausticizing agents.

An alternative technology to recover the cooking chemicals from chemical pulping processes is based on gasification or partial combustion of the spent liquor. Many variants of gasification based processes have been suggested over the past decades.

In U.S. Pat. No. 4,682,985 Kohl and coworkers suggest a chemicals recovery system based on gasification wherein a concentrated aqueous black liquor containing carbonaceous material and alkali metal sulfur compounds is treated in a gasifier vessel containing a relatively shallow molten salt pool at its bottom to form a combustible gas and a sulfide-rich melt. The gasifier vessel has a black liquor-drying zone at its upper part wherein all the black liquor is injected. Dry black liquor solids are falling down through the reactor to a black liquor solids gasification and molten salt sulfur reduction zone which comprises a molten salt pool. A first portion of an oxygen-containing gas is introduced into the gas space in a gasification zone located immediately above the molten salt pool. The remainder of the oxygen-containing gas is introduced into the molten salt pool in an amount sufficient to cause gasification of carbonaceous material entering the pool from the gasification zone, but not sufficient to create oxidizing conditions in the pool. A combustible gas is withdrawn from an upper portion of the drying zone, and a melt in which the sulfur content is predominantly in the form of alkali metal sulfide is withdrawn from the molten salt sulfur reduction zone. Although the process of U.S. Pat. No. 4,682,985 is of utility in providing a combustible gas and an alkaline molten salt product (albeit standard alkalinity kraft smelt chemicals) it is well recognized that the injection of oxygen into a smelt pool is associated with technical and safety problems. Corrosion and destruction of containment materials are generally inherent in the use of turbulent pools of molten salts. Certain improvements to U.S. Pat. No. 4,682,985 is suggested by Kohl and coworkers in U.S. Pat. No. 4,773,918, however the presence of a porous char bed of solid carbonaceous material in the bottom of the gasification zone, oxygen diffusion into the char bed and gasification of dried particles falling down to the char bed to support char bed reactions, is complex and raises significant technical and safety concerns.

Partial combustion of cellulose spent liquor is performed in a gas generator of the type described in U.S. Pat. No. 4,808,264 (Kignell). According to the process description, droplets of molten alkaline compounds and a hot combustible gas comprising carbon monoxide and hydrogen are formed. The gas and alkaline compounds are separated in a quench vessel, arranged directly below the gas generator. While use of the gasifier system of U.S. Pat. No. 4,808,264 may have advantages over other types of gasifiers suggested for black liquor applications, the direct contact of hot gases comprising the alkali in the quench leads to undesired reactions between carbon dioxide and alkali, resulting in the formation of sodium bicarbonate and lower alkalinity of the recovered pulping liquor. Improvements to the design of the quench vessel of U.S. Pat. No. 4,808,264, is proposed by Stigsson in U.S. Pat. No. 5,814,189, however a down-draft gasifier/quench design wherein both gases and all the smelt formed have to pass through the quench throat provides a large contact surface between alkali and carbon dioxide, and therefore limits the scope for recovery of strongly alkaline cooking liquor chemicals.

From the foregoing description and prior art disclosures it is recognized that it is critical to preserve the alkalinity of the recovered pulping chemicals and to prevent undesired reactions between alkali and carbon dioxide. The various gasification recovery systems disclosed in prior art references are not specifically designed for the recovery of alkali forming strongly alkaline pulping liquors upon dissolution of smelt in an aqueous medium.

It is therefore needed a black liquor recovery process which on one hand provides the benefits of a gasification process and on the other hand also ensure that the alkalinity of cooking chemicals is preserved.

### BRIEF SUMMARY OF THE INVENTION

The present invention relate to a catalytic two-stage gasification process using a gas generator for the recovery of alkaline chemicals and energy value from a cellulose spent liquor. The process and gas generator is specifically designed for the recovery of alkaline molten compounds which upon dissolution in an aqueous liquids forms strong alkali. By the combustion of cellulose spent in an oxygen containing gas in a first reaction zone of the gas generator, a gaseous stream comprising entrained alkaline particles and a molten alkaline slag product is formed. The temperature in the first reaction zone is maintained between 1000 C. and 1400 C., preferably maintained at a temperature above about 1150 C., by the controlled addition of oxygen containing gas. The alkaline molten slag product comprising alkali oxide, alkali hydroxide, alkali carbonate and alkali borate's corresponding to at least 75% by weight of the smelt, is separated from the gaseous stream and dissolved in an aqueous liquid to form a strongly alkaline raw cooking liquor. The gaseous components stream formed by exothermal reactions in the first reaction zone are directed to a second reaction or gas transfer zone of substantially of updraft or up-flow design, wherein the gases are cooled to a temperature below about 1000 C. In a preferred embodiment of the invention, a second increment of cellulose spent liquor is injected in the second reaction or gas transfer zone too cool the hot gaseous stream from the first reaction zone. By gravity a significant portion of entrained and freshly formed alkaline slag material will be conveyed downwards through the second reactor or gas transfer zone to combine with the molten slag in the bottom slag discharge zone below the first reaction zone of the gas generator.

### DETAILED DESCRIPTION OF THE INVENTION

In chemicals recovery processes for alkaline pulping chemicals it is of great importance to preserve alkalinity of the cooking chemicals throughout the recovery process and to prevent undesired reactions between alkali and carbon dioxide. Carbon dioxide reacts readily with alkali carbonate and hydroxide in any aqueous phase present and eventually forms alkali hydrogen carbonate.

The recovery process of the present invention is specifically targeted to the efficient recovery of highly alkaline compounds and to preserve alkalinity of the chemicals recovered. Alkali hydrogen carbonate should not be present in the recovered pulping liquor. This is accomplished by a novel and innovative design of a gasification reactor further described in the following.

Gasification of carbonaceous material for the recovery of energy and chemicals is a well established technology and three basic process concepts are normally used: fixed bed gasification, fluidized bed gasification and suspension or entrained flow gasification. Cellulose spent liquors contains a large fraction of alkali compounds with a low melting and agglomeration point and although various fluidized bed concepts have been disclosed for conversion of cellulose spent liquors, it is generally agreed that a suspension or entrained flow gasifier is more suitable for conversion of the highly alkaline liquor. Fixed bed gasifiers are not practical for conversion of liquid fuels. The gasifier or gas generator of the present invention can be categorized as an catalytic two-stage entrained flow gasifier with recycle of inorganic material to the primary gasification stage.

The cellulose spent liquor (black liquor) which is fed to the gasifier of the present invention contains the inorganic cooking chemicals from the pulping process along with the lignin and other organic matter separated from the lignocellulosic material. The black liquor is concentrated to firing conditions using evaporators and concentrators to a solids content ranging from about 65% to about 85%. The kraft liquor elementary composition is mainly hydrogen, carbon, oxygen, sulfur and a large inorganic fraction comprising alkali metal compounds.

In a preferred embodiment of the present invention the sulfur content of the spent cooking liquor is low and the proposed process is therefore particularly advantageous for the recovery of chemicals from soda alkaline pulping processes with a cooking liquor sulfidity lower than 10%. A sulfur free pulping operation considerably facilitates the chemicals recovery and flue gas clean up. There is no need for recovering sulfur in reduced form. Oxidizing conditions can be applied in various sections of the recovery unit. Non process sulfurous components can, if necessary, be bled out from the chemical liquor loop continuously or from time to time.

Alkali is a well-known catalyst for gasification of carbonaceous material and alkali is present in large quantities in the black liquor feed material. The rate of decomposition of the black liquor is thus significantly enhanced by the catalytic action of sodium and other alkali compounds present in the gasification zones of the gas generator. The alkali present in the black liquor is also an active ingredient or precursor to the formation of green liquor, a main product obtained by the gasification of black liquor.

In a preferred embodiment of the present invention, the spent liquor feed to the gas generator comprises alkali borate compounds in support of autocausticizing reactions in the gasifier. The sodium to boron content of the black liquor may vary, but should be adjusted and kept in a range corresponding to a sodium to boron molar ratio of between 2 to 6.

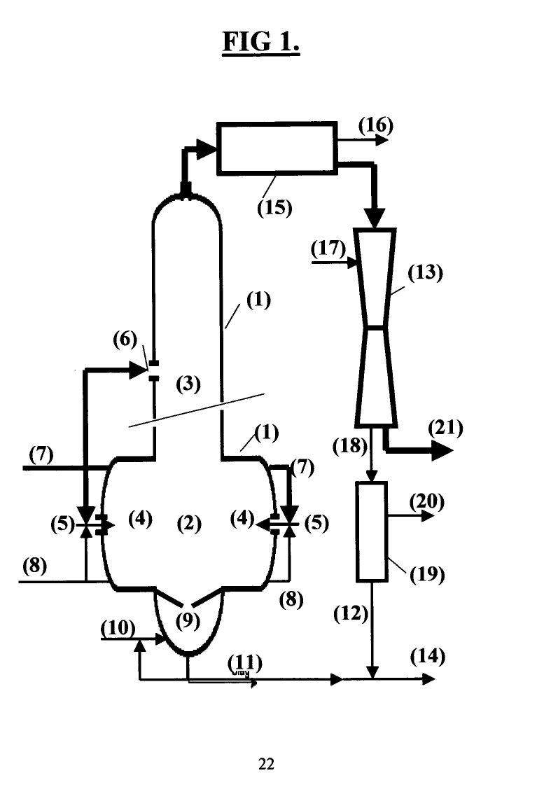

The gas generator of the present invention will be described in the following text body and in appended FIG. 1.

In a horizontal or down-flow arranged first reaction zone of a two-stage catalytic gas generator spent cellulose liquor is reacted with an oxygen containing gas at a first temperature in the range of approximately 1000 C. to 1400 C., preferably at a temperature above about 1150 C., and at a pressure in the range of about 0.1 MPa to about 10 MPa to produce a gaseous stream comprising H₂, CO, CO₂ , H₂O and entrained alkali droplets and a molten slag product comprising at least 75 weight % alkali carbonate, alkali hydroxide, alkali oxide and alkali metal borate. In a following second reaction or gas transfer zone, substantially arranged updraft or up-flow relative to the first reaction zone, the gaseous stream comprising entrained alkali droplets is cooled to a second temperature below about 1000 C. by indirect heat exchange with water or steam or by the injection of cellulose spent liquor.

The term oxygen containing gas, as used herein is intended to include air, oxygen-enriched air, i.e. greater than 21 mole % oxygen, and substantially pure oxygen, i.e. greater than 95 mole % oxygen, the remainder comprising N₂ and rare gases. Oxygen containing gas may be fed to the gas generator at a temperature in the range from ambient to about 200 C.

The cellulose spent liquor is usually preheated to a temperature in the range of 100 to 150 C., generally to a temperature of at least 120 C. before it is injected to the gas generator by way of one or more burners equipped with atomizing nozzles. Oxygen, nitrogen, steam or recycled fuel gas or combinations of these gases can be used to support the atomization of the cellulose spent liquor in to a spray of small droplets.

The quantity of oxygen supplied by the oxygen containing gas to the gas generator for supporting partial oxidation of the combined streams of spent cellulose liquor correspond to about 20-70% of the stoichiometric oxygen consumption for complete combustion of the spent liquor. Using substantially pure oxygen feed to the gas generator as an example, the composition of the gaseous stream leaving the two-stage gas generator (in mole % dry basis) may be as follows: H₂ 25 to 40%, CO 40 to 60%, CO₂ 2 to 25% and CH₄ 0.01 to 4%. The calorific value of the raw gaseous stream exiting the second reaction or gas transfer zone expressed as a function of wood charged to the pulping process, will be highly dependent on the actual yield of the pulping process and degree of wet combustion in any oxidative delignification stages returning spent liquor to the chemicals recovery. A typical raw gas higher heating value using pure oxygen as oxidant and estimating a pulp yield on wood around 50%, would be on the order of 6-12 MJ/Nm3 dry gas.

It is desirable to operate the first reaction zone compartment of the gas generator at a high and relatively constant temperature in order to obtain the desired and highly alkaline molten inorganic slag composition. Preferably the temperature in the first reaction zone should be above 1150 C. and more preferable a temperature in the range of 1200-1300 C. The alkaline slag material obtained in the first reaction zone comprises at least 75 % by weight of sodium oxide, sodium hydroxide, sodium carbonate and sodium borate's or their potassium analogues. A typical product smelt compositions resulting from the gasification of boron containing black liquor is (by weight of recovered smelt) 2-20% sodium hydroxide (NaOH), 2-10% sodium oxide, 5-20% sodium metaborate (NaBO₂), 5-30% tetrasodium diborate (Na₄B₂O₅)., 10-70% trisodiumborate (Na₃BO₃) and the balance sodium carbonate (Na₂CO₃) and minor non process elements.

The high temperature in the first reaction zone can be accomplished by adjusting the oxygen/black liquor ratio up or down as required to maintain the desired temperature. If other parameters such as black liquor composition, oxygen gas preheat, and heat losses are constant, this mode of operation will result in the production of a product alkaline slag of relatively constant composition.

As is apparent from the foregoing description a key function of the recovery system is to recover alkaline chemicals in a form useful for cost effective conversion to fresh and highly alkaline cooking liquor. In order to minimize the contact of carbon dioxide in the combustible gas with the alkaline slag, the slag obtained in the first reaction zone of the gas generator is separated from the gaseous stream gas in a separate gas diversion and slag separation zone arranged below the first reaction zone. The separation is supported by gravity or other means and the slag is removed from the first reaction zone of the gas generator through a bottom valve system. A major portion, preferably more than 70% by weight of the alkaline slag formed in the two-stage gas generator, is recovered and removed by the bottom valve system of the gas generator. The balance alkaline material will follow the gaseous stream as entrained droplets and particles. Such particles is recovered downstream the gas generator and may optionally partly or fully be recycled to cellulose gas generator spent liquor feed, in which latter case substantially all alkaline material is recovered and removed through the bottom valve system of the gas generator.

Due to the high operating temperature in the first reaction zone of the gas generator a substantial fraction of molten alkaline material, particles and fumes will follow the gaseous component stream into the second reaction or gas transfer zone. In a preferred embodiment of the present invention, additional black liquor is injected into the second reaction or gas transfer zone in one or more nozzles in order to cool the gaseous stream to a temperature below about 1000 C. Thereby the additional black liquor is decomposed under endothermal conditions to gases and alkaline inorganic material. Alternatively or combined with black liquor injection into the gaseous stream, the gaseous stream formed in the first reaction zone may be cooled in the second reaction or gas transfer zone by indirect heat transfer to steam or hot water circulating in tubes arranged gas generator walls.

Upon cooling the gaseous stream in the second reaction or gas transfer zone alkaline fumes agglomerates and combines to larger particles. By gravity a significant portion of entrained and freshly formed alkaline slag material is conveyed downwards through the second reaction or gas transfer zone, as smelt on the gas generator walls or as particles, agglomerates and droplets falling counter current through the gaseous stream. The alkaline material thus combines with the molten slag in the bottom slag discharge zone located below the first reaction zone of the gas generator. A large portion of the alkali material thus have been exposed to the high temperature in the first reaction zone of the gas generator at conditions favorable for the formation of highly alkaline compounds such as sodium triborate, sodium hydroxide and sodium oxide.

After the second reaction or gas transfer zone the gaseous stream is treated for particulate removal and heat recovery in a suitable sequence. While recovering energy from the physical heat in the gas, the temperature of the gaseous stream is lowered to a temperature below about 250 C.

As much as 30% or more of the total quantity of alkaline slag or particles formed during gasification of black liquor in the two-stage gas generator of the present invention may leave the second reaction or gas transfer zone as carryover. This carryover material may be removed from the gaseous stream by particulate removal systems such as bag filters or electrostatic precipitators. Depending on the alkalinity of the liquid upon dissolution of this particulate material in an aqueous liquid, it may be used directly for providing alkali in oxygen delgnification stages or be combined with the green liquor recovered from smelt, or alternatively be recycled to gas generator feed streams.

Removal of carryover particulate material entrained in the gaseous stream exiting the gas generator, can also be performed by using a gas quench or venturi scrubber system, wherein an aqueous scrubbing liquid is injected directly in to the gaseous stream. The alkaline particles separated in the gas quench or venturi scrubber is thus separated and dissolved in an aqueous quench liquid. As this liquid has been exposed to carbon dioxide present in the gaseous stream during quenching, alkali bicarbonate may have been formed. As this is a clearly undesired component, the liquid must be processed before it can be combined with the strongly alkaline green liquor originating from the molten alkaline slag recovered from the gas generator. Removal and conversion of alkali bicarbonate to provide a more alkaline alkali carbonate solution is conducted by thermal treatment, decompressing and flashing off carbon dioxide from the quench liquid or by combinations of these methods.

A major portion of the alkaline molten slag formed in the first reaction zone and inorganic molten droplets and aerosols formed in the gas generator and conveyed downwards in the gas generator are removed by the bottom valve system of the gas generator. The alkaline molten slag product is dissolved in an aqueous solution which upon dissolution comprises alkaline compounds in a form suitable for direct use as alkali buffer in pulping and oxygen delignification stages in a pulp mill. The content of alkali hydrogen carbonate of the recovered alkaline liquor is practically zero and in any case always below about 2 grams/liter. If a higher alkalinity is needed for any step in the delignification process, parts or all of the recovered liquor may be causticized in a causticizing plant commonly used in alkaline pulp mills.

The gaseous stream or combustible raw fuel gas generated in the gas generator of the present invention is free from alkali particles after the smelt separation, particulate removal, heat recovery and gas washing stages. The fuel gas may be used for generating steam in conventional steam generators, as fuel in advanced gas turbine cycles or be used as synthesis gas for the manufacturing of liquid fuels such as methanol or dimethylether.

### BRIEF DESCRIPTION OF THE DRAWING

Reference is made to FIG. 1 which shows the basic layout of one embodiment of the gas generator and auxiliary systems of the present invention.

The gas generator or gasification reactor (1) of the present invention illustrated in FIG. 1. contains two reactor compartments connected to each other. In a first reaction zone (2) located below a second reaction or gas transfer zone (3), black liquor is converted exothermally at a temperature between 1000 C. and 1400 C. into steam, combustible gases and entrained alkali droplets and a highly alkaline molten slag product. The feed stream black liquor comprises boron and sodium compounds in a molar ratio of sodium to boron of about 3. The sulfur content of the black liquor (as elemental sulfur) is lower than 0.3% of the solids. Cyclone or tubular pre-combustion chambers (4) fitted with black liquor injection nozzles are arranged oppositely or in a ring around the first reaction zone (2). In a second and substantially vertically arranged reactor compartment (3) the combustible gases are cooled to a temperature below about 1000 C. by injection of additional black liquor through one or more black liquor injection nozzles (6). There is also provided for a black liquor feed system (7) and gas supply system (8) which includes inlet conduits for an oxygen-containing gas, typically +90% oxygen.

Gas generator (1) have an outer wall provided with a lining of an insulating material capable of withstanding the temperatures and environment within the reactor. Such insulating material is provided in sufficient thickness to minimize, to the extent practical, heat losses from within reactor. Alternatively or combined with insulating material, the reactor walls may fully or partly be protected by a water wall with circulating hot water or steam. In reactor zones operating at a temperature above about 800 C., alkaline slag will then freeze on such tube walls forming a protective layer for corrosion and heat protection.

The bulk of the highly alkaline molten slag formed in the gas generator is drained from the bottom of the generator through a tap hole or slag discharge section (9) followed by a continuous decompressing system (not shown). The highly alkaline smelt comprises a large portion (over 40% by weight of the smelt) trisodium borate (Na₃BO₃). The smelt is dissolved in an aqueous liquid charged through conduit (10) and a raw green liquor is removed from the gas generator through conduit (11). A portion of the green liquor product may be recycled to conduit (10) to aid in breaking up alkaline slag. The raw green liquor is combined with alkaline wash liquor (12) recovered from a gas quench system (13) to form a product alkaline liquor (14) for direct or indirect use as alkaline buffer in alkaline pulping processes.

The hot gases and entrained alkaline droplets and fumes leaving the first reaction zone (2) of the gas generator flow upwards into the second reaction or gas transfer zone of the gas generator (3). Additional black liquor is injected in one or more nozzles in order to cool the combustible gases to a temperature below the ash fusion temperature. By gravity a significant portion of entrained alkaline slag material will flow down through the second reaction or gas transfer zone and combine with the molten slag in the bottom slag discharge zone (9) located below the first reaction zone of the gas generator. Nevertheless as much as 30% or more of the total quantity of alkaline slag or particles formed during gasification of black liquor in the gas generator may leave the second reactor compartment as carryover.

Adjacent the second reaction or gas transfer zone (3) there is provided a gas outlet conduit for the removal of product gases from gas generator (1) to an optional heat recovery device such as a steam generator (15) generating fresh steam (16).

Steam generator (15) is provided with a gas outlet and a conduit for transfer of the gaseous stream comprising alkaline fumes and fine particles to a gas quench system (13) wherein the gases are cooled by the partial evaporation of an aqueous liquid directly injected into the gaseous stream (17) and wherein a major portion of entrained alkaline material is separated from the gaseous stream. Separated and dissolved alkaline material is removed from the gas quench (13) as a spent quench liquid through conduit (18). This spent quench liquid have been exposed to carbon dioxide present in the combustible fuel gas during quenching and alkali bicarbonate may have been formed. As this is a clearly undesired component, the liquid must be processed before it can be combined with the strongly alkaline green liquor originating from the molten alkaline slag recovered from the gas generator. Conversion of alkali bicarbonate present in the quench liquid to alkali carbonate is conducted by thermal treatment, decompressing and flashing off carbon dioxide from the quench liquid or by combinations of these methods in a flash tank (19). Carbon dioxide gases are removed through a vent (20). Provided the flashed off carbon dioxide is free from hydrogen sulfide, it may be discharged to the atmosphere. The spent quench liquid is thereafter discharged through conduit (12) and combined with green liquor (11).

Should flash off gases comprise significant quantities of hydrogen sulfide the gas may be feed to a Claus plant for conversion to liquid elemental sulfur. Such Claus sulfur may be sold, converted to sulfuric acid or charged to a digester or cooking liquor to form polysulfides.

The cooled combustible fuel gases leaving the gas quench (13) has a temperature below about 250 C. The product gas stream (21) may be further treated by heat exchange, cooling, gas washing and particulate removal before it is used for example as a fuel to raise steam, heat or power in a power plant. Specifically hydrogen sulfide, if present in significant concentrations in the product gas stream (21), have to be removed and recycled to the pulp mill in the appropriate form or be exported as sulfuric acid or liquid sulfur.

While certain representative embodiments and details have been shown for the purpose of illustrating the present invention, it will be apparent to those skilled in the art that various changes and modifications can be made without departing from the spirit and scope of the invention.

1. An alkali catalysed two-stage process for the gasification of cellulose spent liquor, which process comprises the steps of:
(a) combusting in a first reaction zone of a gas generator a stream comprising an oxygen containing gas and a cellulose spent liquor at a pressure of from 0.1 to about 10 MPa, evolving heat sufficient to raise the temperature in said reaction zone to a first temperature in the range from 1000 degree C. to 1400 degree C., forming a gaseous component stream and entrained alkali droplets and a liquid alkaline molten slag comprising at least 75% combined weight of alkali oxide, alkali hydroxide, alkali carbonate and alkali borate's,
(b) separating said liquid alkaline molten slag from the gaseous component stream and dissolving liquid molten slag in an aqueous solution, forming an alkaline liquor with an alkali bicarbonate content lower than about 2 grams/liter,
(c) cooling in a substantially vertically arranged second reaction or gas transfer zone of the gas generator said gaseous components stream and entrained slag particles to a second temperature below about 1000 C.,
(d) further cooling the gaseous component stream to a temperature below about 250 C. by at least one of;
i) indirect heat exchange in one or more stages for the generation of fresh steam,
ii) cooling by the direct injection of an aqueous quench liquid into the gaseous component stream
(e) separating entrained alkaline particles from the gaseous component stream and recycling of said particles to a gas generator spent cellulose liquor feed stream or separating entrained alkaline particles from the gaseous component stream and dissolving said particles in an aqueous solution,
(f) discharging the gaseous component stream from step e) for use as a gaseous fuel or for use as a synthesis gas or combinations thereof.

2. The process of claim 1, wherein cooling of the gaseous components stream and entrained slag particles in step c) is achieved by the injection of cellulose spent liquor which liquor under endothermic conditions is decomposed to a stream of gaseous components and alkaline slag particles

3. The process of claim 1 wherein liquid alkaline slag or alkaline slag particles are conveyed by gravity from the second reaction or gas transfer zone counter current to a gaseous component stream, to combine with the alkaline molten slag of step a)

4. The process of claim 1 wherein alkali borate's present in the molten slag of step a) substantially consists of trisodium borate, disodium borate and sodium metaborate or their potassium analogues and combinations thereof.

5. The process of claim 1 wherein alkali borate's present in the molten slag of step a) substantially consists of trisodium borate, disodium borate and potassium triborate or combinations thereof.

6. The process of claim 1 wherein the second temperature after cooling in step c) is in the range of 800 C. to 1000 C.

7. The process of claim 1 wherein the sulfur content of the cellulose spent liquor in step a) measured as elemental sulfur is lower than 2% by weight.

8. The process of claim 1 wherein the molten slag of step a) have a sulfide content corresponding to less than 2% by weight of the smelt.

9. The process of claim 1 wherein the oxygen-containing gas is air, oxygen-enriched air, or oxygen.

10. The process of claim 1 wherein cellulose spent liquor of step a) is recovered from an alkaline soda pulping process with a pulping liquor sulfidity level lower than about 10%.

11. The process of claim 1 wherein aqueous solution of e) is recycled to combine with raw cooking liquor of b)

12. The process of claim 11 wherein carbon dioxide gas is liberated and removed from the aqueous solution prior to combining with the raw cooking liquor of b), said liberation achieved by thermal treatment of the solution, decompression and flashing or combinations thereof to provide an alkaline solution with an alkali carbonate content lower than about 2 g/liter.
